(19) United States
(12) Patent Application Publication
(10) Pub. No.: US 2008/0053169 A1
(43) Pub. Date: Mar. 6, 2008

(54) Theft deterrent device for bags

(76) Inventors: Victoria Marie Ricker, Plainfield, IL (US); Martha Helen Curnow, Schaumburg, IL (US)

Correspondence Address: MCDERMOTT, WILL & EMERY LLP, 227 WEST MONROE STREET, SUITE 4400, CHICAGO, IL, 60606-5096, US

(21) Appl. No.: 11/895,825

(22) Filed: Aug. 28, 2007

Related U.S. Application Data
(60) Provisional application No. 60/840,963, filed on Aug. 30, 2006.
(60) Provisional application No. 60/907,931, filed on Apr. 23, 2007.

(51) Int. Cl. E05B 65/52

(52) U.S. Cl. 70/64

(57) ABSTRACT

A theft deterrent device for use with a bag, such as a purse, backpack or computer bag. The device includes a housing with a connector attached to the housing, and a locking member with a retractable cord attached to an opposing side of the housing for use in securing the bag to a stationary object. The device may further include a second locking member attached to the connector through and attachment means for securing a zipper on a bag to prevent easy access to the contents of the bag.

### CROSS-REFERENCE TO RELATED APPLICATIONS

This application claims priority to U.S. Provisional Patent Application Ser. No. 60/840,963, filed Aug. 30, 2006 and U.S. Provisional Patent Application Ser. No. 60/907,931, filed Apr. 23, 2007. Both applications are incorporated by reference herein.

### FEDERALLY SPONSORED RESEARCH OR DEVELOPMENT

Not Applicable.

### TECHNICAL FIELD

The present application relates to a theft deterrent device, and specifically to a device useful for releasably securing bag items, such as purses, backpacks, diaper bags and computer bags to stationary objects to discourage theft. The present invention further includes a zipper securing device.

### BACKGROUND OF THE INVENTION

Theft of purses and other personal bag items, such as backpacks, briefcases and computer bags is a common problem. Often, the owner of the bag will place the bag on the back of a chair, in a stroller or a grocery cart, inviting easy theft of the entire bag or pickpocketing of wallets, electronic devices or other important items out of the bag. Pickpocketing is often accomplished while the purse or bag is being carried on the person's body as well.

Given the fashionable aspect of most bags, using a pad lock with a cable or combination lock may serve the purpose of locking the bag; however it is not necessarily an attractive or convenient option. Locks and cables would need to be portable and stored when not in use, which may not be convenient for the user. The present invention is designed to provide a user-friendly, portable means for securing a bag to a stationary object, or large movable object, such as a grocery cart, while disguised as a decorative accessory maintaining the fashionable nature of the bag. The present invention further includes a means for securing the zipper on a bag in a closed or partially closed position, to deter theft of articles inside the bag.

### SUMMARY OF THE INVENTION

The present invention generally relates to a theft deterrent device for a bag, such as a purse. In one embodiment, the theft deterrent device comprises a housing, a connector attached to one side of the housing, at least one locking member attached to an opposing side of the housing, a cord having first and second ends, the cord coupled to the locking member, the cord being coupled proximate its second end to a retracting member disposed within the housing for retracting and releasing the cord and the locking member.

According to another embodiment of the invention, the theft deterrent device comprises a housing, a connector attached to one side of the housing, a first locking member attached to an opposing side of the housing, a second locking member attached to the connector, a cord having first and second ends, the cord coupled to the first locking member, the cord being coupled proximate to its second end to a retracting member disposed within the housing for retracting and releasing the cord and the first locking member, and a second locking member connected to the connector through a plurality of rings.

According to yet another embodiment of the present invention, the theft deterrent device comprises a connector, an attachment means, and a locking member.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is perspective view of the theft deterrent device of the present invention.

FIG. 2 is a detailed perspective view of the theft deterrent device of the present invention.

FIG. 3 is a detailed perspective view of one embodiment of the theft deterrent device of the present invention.

FIG. 4 is a front view of the housing of the theft deterrent device of the present invention.

FIG. 5 is a cross sectional view taken along lines 5-5 of the housing of FIG. 6.

FIG. 6 is a perspective view of another embodiment of the theft deterrent device of the present invention.

FIG. 7 is a perspective view of another embodiment of the present invention.

### DETAILED DESCRIPTION

While this invention is susceptible of embodiments in many different forms, there are shown in the drawings and will herein be described in detail, preferred embodiments of the invention with the understanding that the present disclosures are to be considered as exemplifications of the principles of the invention and are not intended to limit the broad aspects of the invention to the embodiments illustrated.

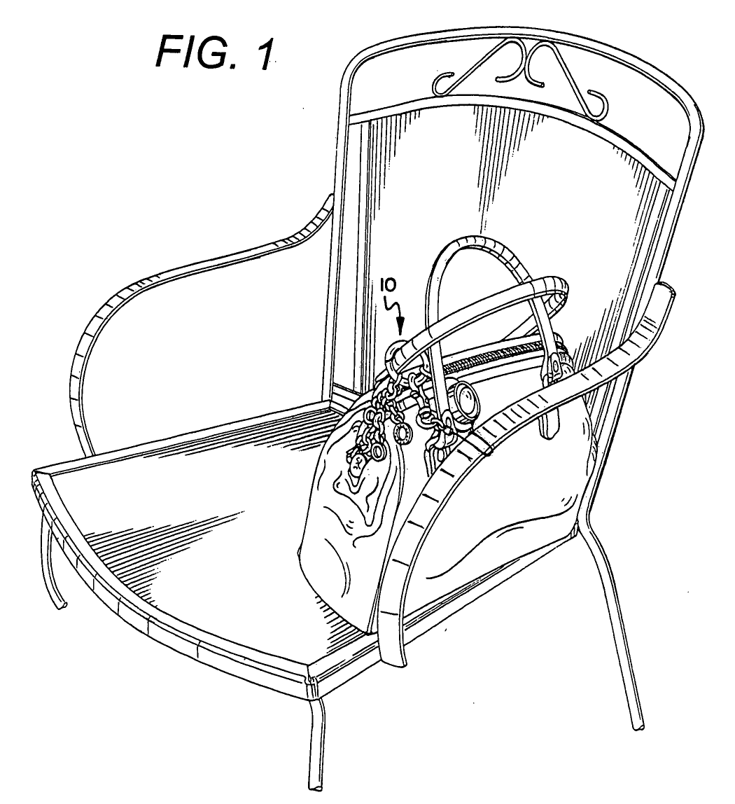

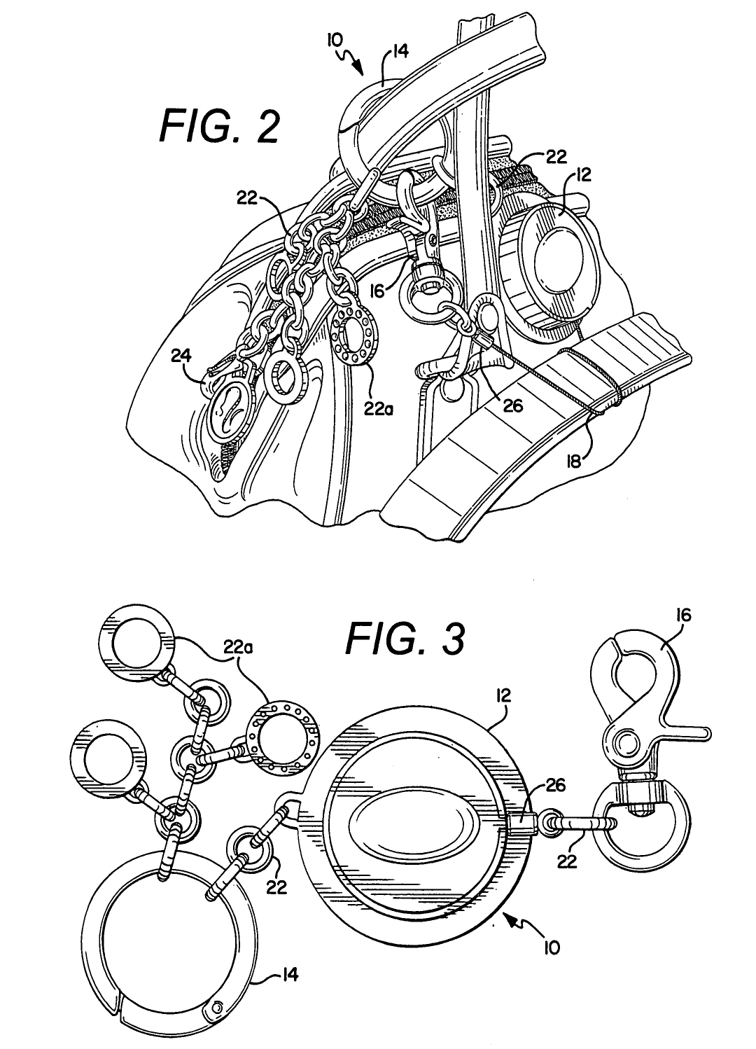

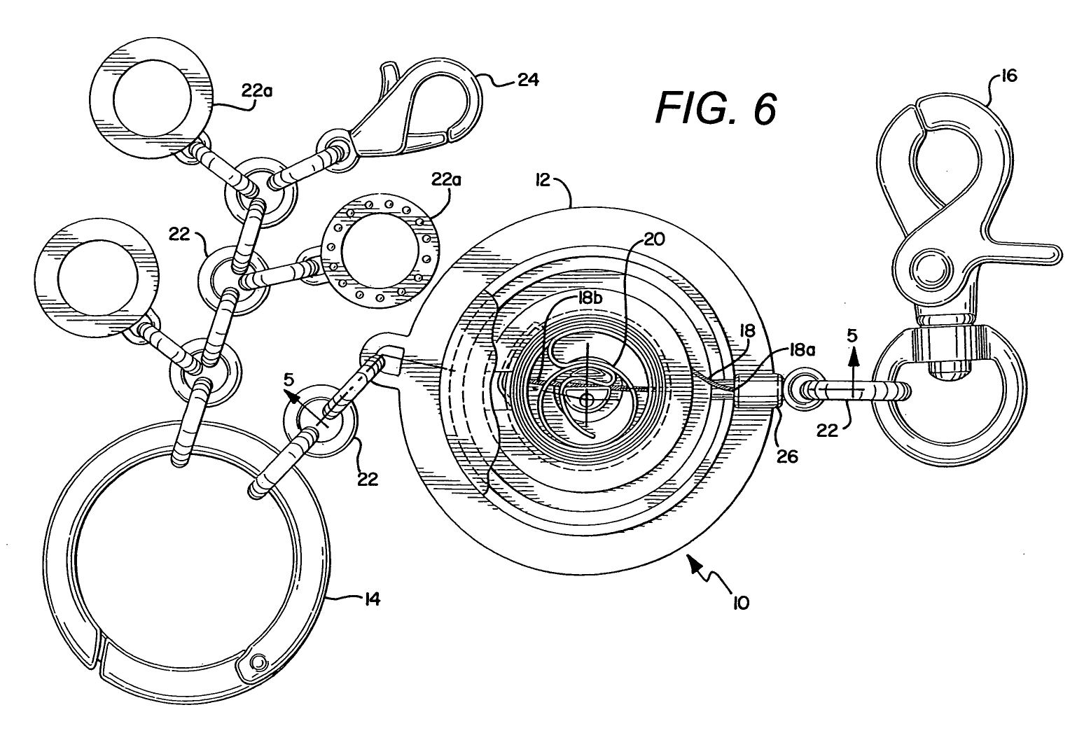

Turning now to the Figures, FIG. 1 is a perspective view of the first embodiment of the present invention, showing the invention in use as a theft deterrent device 10, for securing a bag or purse to a stationery object, such as a chair, or to a large movable object, such as a grocery cart. In general, and as shown in FIG. 2, the device 10 comprises a housing 12, a connector 14 attached to one side of the housing through attachment means 22, at least one locking member 16 attached to an opposing side of the housing through attachment means, a cord 18 having first 18a and second end 18b, the first end coupled to the locking member through a casing 26 and attachment means, and the second end coupled proximate to a retracting member 20, shown in FIGS. 5 and 6, disposed within the housing for retracting and releasing the cord and the locking member. The device 10 and its component parts can be constructed of any durable material, such as plastic or metal.

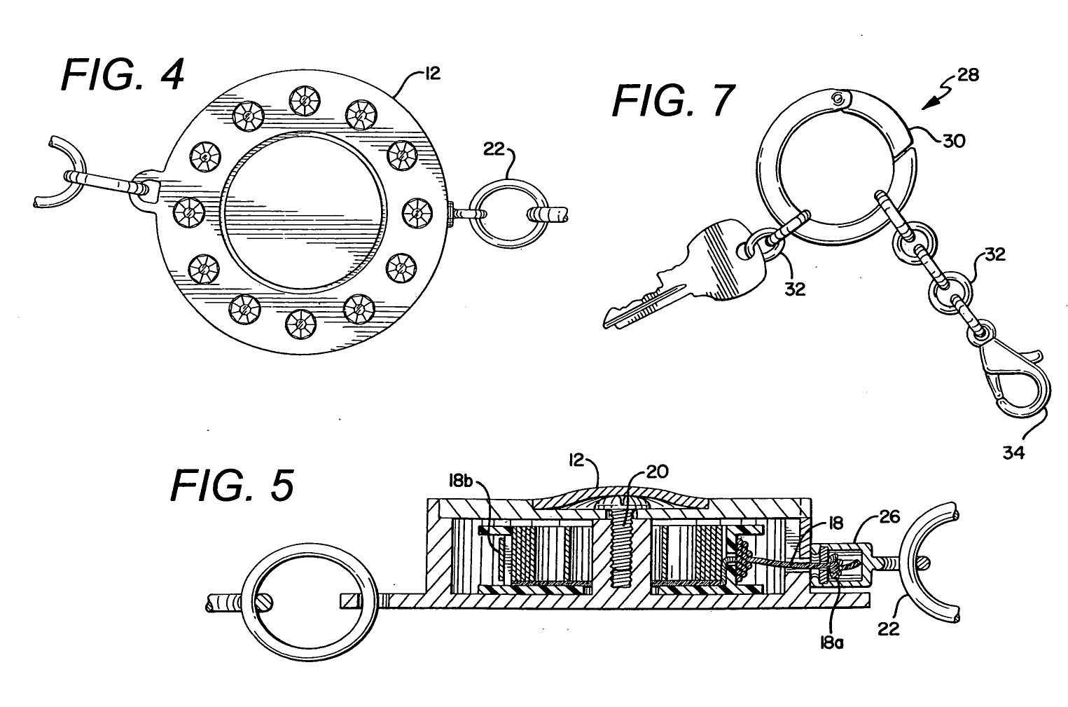

As shown in FIGS. 3 and 4, the device 10 comprises a housing 12. The housing 12 includes a connector 14 attached to one side of the housing and a locking member 16 attached to an opposing side of the housing. The housing 12 can have any geometric shape, such as square, oval, circular, etc. Preferably, the housing 12 is circular and can be constructed of any suitable durable material, such as plastic or metal. As shown in FIG. 4, the housing 12, including the outer cover of the housing, can include a decorative element, such as crystals or faux gems, engraved wording, silk flowers, etc.

As shown in FIG. 6, a retracting mechanism 20 is located within the interior of the housing 12. The retracting member 20 includes a spring loaded mechanism, as is generally known in the art.

As shown in FIG. 3, one end of the housing 12 includes a connector 14. The connector 14 can be attached to the housing 12 by any suitable attachment means 22, including a chain, wire, cord or cable. Preferably, the attachment means is at least one metal chain link or ring, which permits movement between the connector 14 and the housing 12. The connector 14 can be any suitable geometric shape, preferably circular. The connector 14 should be easy to attach to and remove from the strap of a bag, and therefore a biased closure member, movable between open and closed positions, is preferred. Preferably, the connector 14 is a split ring, which opens with slight inward pressure and biases toward a closed position to seal the opening. The connector 14, however, could be of any form suitable for securing and removing the device 10 to the bag, and thus could include a clip, clasp or any other suitable means for removing and attaching the device to the bag.

As further shown in FIG. 3, also attached to the housing 12 is at least one locking member 16. The locking member 16 is secured to the housing 12 through an attachment means 22, including a link or ring, a casing 26 and a cord 18 secured within the housing, as shown in FIG. 5. The locking member 16 can be any form of securing member such as a toggle, hook, or snap clasp. Preferably, the locking member 16 is a lobster claw clasp. As with the housing 12, the locking member 16 can be constructed from any durable material, such as plastic or metal. Preferably, the locking member 16 is constructed from a lightweight metal for security, longevity after repeated use, as well as decorative appeal. When in use, the locking member 16 attaches to the connector 14 securing the bag to the stationary object.

Referring to FIG. 5, on the attachment means 22 opposite to the locking member 16, is connected a retractable cord 18 having first end 18a and a second end 18b. The first end 18a of the cord 18 is attached by a secure method such as a knot or gluing, within a casing 26 which is secured to the attachment means 22 and then to the locking member 16. When not in use, the cord 18 is retracted and stored within the housing 12, with the second end of the cord 18b wrapped around a spool portion of a retracting member 20, and further secured within the retracting member by knotting or gluing. The retracting member 20 can be a standard spring loaded mechanism known in the art, such as a flat coil spring surrounded by a plastic spool. The retracting member 20 permits easy release of the cord 18 from the housing 12 using the locking member 16. The cord 18 is then wrapped around the portion of the stationary object, such as the arm of a chair, and the locking member 16 is secured to the connector 14, securing the bag to the stationary object. When the locking member 16 is released from the connector 14, the retracting member 20 automatically winds the cord 18 back into the housing 12. The cord 18, which can be any length suitable for the present invention, can be made from any durable, strong, flexible material so that it is not easily broken, such as stainless steel, nylon, flexible wire or plastic. Preferably, the cord 18 is nylon or plastic coated stainless steel.

FIG. 6 shows a second embodiment of the present invention. This embodiment includes a second locking member 24. The second locking member 24 is attached to the connecting member 14 through a suitable attachment means 22, including a chain, wire, cord or cable, and similar to those used in connection with the first locking member 16. Preferably, the attachment means 22 is at least one chain link or ring, the number of which create a length suitable for the second locking member 24 to reach the zipper of the bag, and to permit movement between the second locking member and the connecting member 14. As described above, the second locking member 24 can be any form of securing member, such as a hook or snap clasp, but is preferably a lobster claw clasp.

As shown in FIG. 6, the second locking member 24 adds to the theft deterrent feature of the present invention because it secures the zipper on the bag in either the closed position, or it prevents the zipper from being fully opened permitting access to the contents of the bag. When the second locking member 24 is engaged, it would be difficult to open the zipper of a bag without the wear's knowledge. Use of the second locking member 24 deters pickpocketing of items from the bag. In addition, decorative elements, such as charms or jeweled rings 22a can be added, either permanently or removably to the attachment means 22, adding a further decorative feature to the device 10.

As shown in FIG. 7, yet another embodiment of the present invention is directed to a zipper lock 28. The zipper lock 28 includes a connector 30 of the type described above. Attached to the connector 30 is an attachment means 32, including a chain, wire, strap, cord or cable, as described above. Preferably, the attachment means 32 is a plurality of chain links or metal rings. Secured on the opposing end of the chain links is a securing member 34, such as a toggle, hook or clasp. In use, the connector 30 would receive the strap of the bag, purse, backpack, etc., and the securing member 34 would be attached to the zipper tag at the end of the zipper on the bag. The zipper lock 28 would prevent the zipper on the bag from being opened easily without the knowledge of the owner of the bag. As an alternative, decorative charms or jewels can be added to the attachment means 32, adding to the fashionable element of the lock. Alternatively, keys, such as house or car keys or pass keys can be added to the connector 30 through the attachment means 32.

Referring to FIGS. 1, 2, and 6 to use the device of the present invention, the owner of the bag would attach the connector 14 to the strap of the bag by pushing the opening of the connecting member against the strap or metal hardware on the bag. The user would pull on the locking member 16, releasing the cord 18 from the retracting member, to a desired length for attachment to the chair, stroller, cart, etc. The cord 18 would then be wound around the portion of the chair, such as an arm, and the locking member 16 would be attached to the connector 14. In this manner, the bag is secured to a stationary object or large, but movable object such as a grocery cart, discouraging easy removal of the bag or its contents. According to the second embodiment of the invention, the second locking member 24 is attached to the connector 14 through an attachment means 22, having a length suitable to reach the zipper of the bag. The user would attach the clasp 24 to the zipper tag at the end of the zipper. This second locking member 24 secures the zipper in the closed position, or prevents the zipper from being fully opened, to deter removal of items from the bag without the owner's knowledge. Upon removal of the bag from the chair, the locking member 16 is released from the connector 14 and the cord 18 is automatically rewound on the retracting member 20 inside the housing.

In yet another embodiment of the present invention, the device may be sewn into the lining of the purse or bag. Specifically, the housing 12 would be sewn into the lining, either interior or exterior lining of the handbag, backpack, briefcase, etc. The attachment means 22 and the first locking member 16, and optionally the second locking member 24 would protrude out from the lining, such that when the first locking member and cord 18 are pulled out from the housing, the housing remains secured within the lining. The device 10 would function in the same manner to secure the bag to a stationary object as previously described. Optionally, the second locking member 24 would also be used to secure the zipper on the bag, as previously discussed.

While the specific embodiments have been illustrated and described, numerous modifications come to mind without significantly departing from the spirit of the invention, and the scope of protection is only limited by the scope of the accompanying Claims

What is claimed is:

1. A theft deterrent device for a bag, the device comprising:
a housing
a connector attached to one side of the housing;
at least one locking member attached to an opposing side of the housing;
a cord having first and second ends,
the cord being coupled to the locking member, the cord being coupled proximate to its second end to a retracting member disposed within the housing for retracting and releasing the cord and the locking member.

2. The theft deterrent device of claim 1, wherein the connector is releasably connected to the bag.

3. The theft deterrent device of claim 2, wherein the connector is a ring biased to a closed position and movable between an open and a closed position.

4. The theft deterrent device of claim 1 wherein the locking member is attached to the housing through an attachment means.

5. The theft deterrent device of claim 4, wherein the attachment means comprises at least one chain link or ring.

6. The theft deterrent device of claim 1, wherein the locking member is a clasp.

7. The theft deterrent device of claim 1, wherein the locking member is a toggle and ring.

8. The theft deterrent device of claim 1, wherein the retracting member includes a spool for receiving the cord.

9. The theft deterrent device of claim 1, further including a second locking member connected to the connector through an attachment means.

10. The theft deterrent device of claim 9, wherein the second locking member is a clasp.

11. The theft deterrent device of claim 9, wherein the attachment means is a plurality of chain links or rings.

12. The theft deterrent device of claim 1, wherein the device is designed for securing at least one of a purse, backpack, diaper bag, laptop bag, or briefcase.

13. A theft deterrent device for securing a bag to a stationary object, the device comprising:
a housing;
a connector attached to one end of the housing;
a first locking member attached through an attachment means to an opposing side of the housing from the connector;
a cord having first and second ends coupled to the locking member;
a retracting member disposed within the housing for retracting and releasing the cord and releasably securing the cord around the stationary object and the locking member to the connector;
a second locking member connected to the connector; and,
a plurality of rings linking the second locking member to the connector.

14. A theft deterrent device for securing a zipper on a bag, the device comprising:
a connector biased to a closed position and movable between an open and a closed position; and,
at least one locking member attached to the connector through an attachment means.

15. The theft deterrent device of claim 14, wherein the attachment means is a plurality of chain links or rings.
